(19) United States
(12) Patent Application Publication
(10) Pub. No.: US 2010/0281868 A1
(43) Pub. Date: Nov. 11, 2010

(54) GAS TURBINE ENGINE COMBUSTER

(75) Inventors: Mehmet Dede, West Chester, OH (US); Osman Buyukisik, West Chester, OH (US)

Correspondence Address: ADAMS INTELLECTUAL PROPERTY LAW, Suite 2350 Charlotte Plaza, 201 South College Street, CHARLOTTE, NC, 28244, US

(73) Assignee: General Electric Company, Schenectady, NY (US)

(21) Appl. No.: 11/965,880

(22) Filed: Dec. 28, 2007

(51) Int. Cl. F02C 3/14

(52) U.S. Cl. 60/722

(57) ABSTRACT

A combustor for a gas turbine engine, and including an integrated dome and deflector having a conical shape optimized for each individual combustor cup in an array of combustor cups, as determined by CFD analysis for eliminating combustor air recirculation zones and swirling. A related method is also disclosed.

### BACKGROUND OF THE INVENTION

This application relates generally to gas turbine engines and, more particularly, to combustors for gas turbine engines.

At least some known gas turbine engines include a compressor that provides compressed air to a combustor where the air is mixed with fuel and ignited for generating hot combustion gases. The gases flow downstream to one or more turbines that extract energy to power the compressor and provide useful work, such as to power an aircraft in flight.

At least some known combustors used in gas turbine engines typically include inner and outer combustion liners joined at their upstream ends by a dome assembly. The dome assembly includes an annular spectacle plate or dome plate and a plurality of circumferentially spaced swirler assemblies or cups. Fuel is supplied to the dome where it is mixed with air discharged from the swirler assemblies to create a fuel/air mixture that is channeled to the combustor.

At each combustor cup, as the combustor air exits the swirlers, it expands and swirls with a significant tangential velocity. Expanding air velocity profile has a natural axi-symmetric conical shape. Current dome and deflector designs do not follow this natural conical axi-symmetric shape, causing the air to expand unevenly in the radial and tangential directions. This generates severe hot gas recirculation zones. These zones trap hot gases and bring them to the close proximity of the deflector in a manner that can cause damage to the dome and deflector.

Current combustor designs have flare cones that follow the natural conical shape of the flow. However the axial length of the flare cones are extremely short. In the flare, the expansion is incomplete. As the air exits the flare, it keeps expanding further in its natural conical shape. Deflectors do not follow the natural shape of the expanding air flow, thus causing recirculation zones. Burning fuel becomes trapped in these zones, causing damage to the combustor hardware.

Therefore, there is a need for a combustor design that eliminates re-circulation zones so that hot gases are not brought in contact with the surface of the deflector. There is also a need for a combustor design that provides improved impingement cooling on the back side of the deflectors to remove heat loading due to radiation.

### BRIEF SUMMARY OF THE INVENTION

In one aspect, a combustor for a gas turbine engine is provided that eliminates re-circulation zones so that hot gases are not brought in contact with the surface of the deflector.

In another aspect, a combustor for a gas turbine engine is provided that includes an integrated dome and deflector having a conical shape optimized for each individual combustor cup in an array of combustor cups, as determined by CFD analysis for eliminating combustor air recirculation zones and swirling.

In another aspect, the gap between adjacent dome and deflector surfaces is contoured to permit combustor air to expand as it moves downstream for providing air cooling on metal dome and deflector surfaces.

In yet another aspect, the integrated dome and deflector form a gap therebetween having a first shape defined by a vertical cross-section of the edge portions of the dome and deflector and a second shape defined by a horizontal cross-section of the edge portions of the dome and deflector.

In yet another aspect, the integrated dome and deflector each have a conical shape optimized for each individual combustor cup in an array of combustor cups, as determined by CFD analysis for eliminating combustor air recirculation zones and swirling.

In yet another aspect, the gap between adjacent dome and deflector surfaces is contoured to permit combustor air to expand as it moves downstream for providing air cooling on metal dome and deflector surfaces.

In yet another aspect, the integrated dome and deflector form a gap therebetween having a first shape defined by a vertical cross-section of the edge portions of the dome and deflector and a second shape defined by a horizontal cross-section of the edge portions of the dome and deflector.

In yet another aspect, a method of optimizing combustor air flow through a deflector and dome of a gas turbine engine combustor is provided that includes the steps of forming an integrated dome and deflector having a conical shape optimized for each individual combustor cup in an array of combustor cups, as determined by CFD analysis for eliminating combustor air recirculation zones and swirling.

### BRIEF DESCRIPTION OF THE DRAWINGS

FIG. 1 is a schematic illustration of a gas turbine engine;

FIG. 2 is a diagram of a combustor cup of a prior art velocity profile of the expanding air exiting the combustor cup;

FIG. 3 is a flow diagram showing prior art velocity zones that trap hot gases and bring them to the close proximity of the deflector, causing damage to the metal of the combustor;

FIG. 4 is a horizontal cross-section of the velocity profile shown in FIG. 3;

FIG. 5 is a vertical cross-section of the velocity profile shown in FIG. 3;

FIG. 6 is a side elevation showing a deflector and dome integrated to form a conical shape for a combustor cup;

FIG. 7 is a side elevation showing part of the dome cut away to indicate the inner edge surface profile of the dome and upstream portions of the outer edge surface profile of the deflector;

FIG. 8 is a fragmentary view showing a vertical cross-section of the outer edge surface profile of the dome and upstream portions of the outer edge surface profile of the deflector;

FIG. 9 is a fragmentary view showing a horizontal cross-section of the outer edge surface profile of the dome and upstream portions of the outer edge surface profile of the deflector;

FIG. 10 is a fragmentary view showing a vertical cross-section of the outer edge surface profile of the dome and upstream portions of the outer edge surface profile of the deflector, with the deflector edges shortened in relation to the dome;

FIG. 11 is a fragmentary view showing a horizontal cross-section of the outer edge surface profile of the dome and upstream portions of the outer edge surface profile of the deflector, with the deflector edges shortened in relation to the dome.

### DETAILED DESCRIPTION OF THE INVENTION

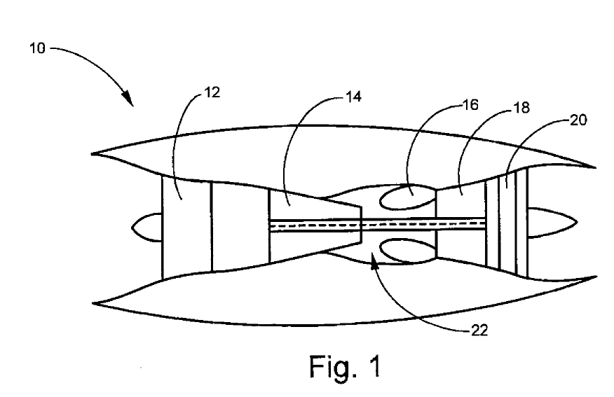

Referring now specifically to the drawings, FIG. 1 is a schematic illustration of a gas turbine engine 10 including a low pressure compressor 12, a high pressure compressor 14, and a combustor 16. Engine 10 also includes a high pressure turbine 18, and a low pressure turbine 20 arranged in a serial, axial flow relationship. Compressor 12 and turbine 20 are coupled by a first shaft 24, and compressor 14 and turbine 18 are coupled by a second shaft 26. In one embodiment, gas turbine engine 10 is a GE 90-94B engine commercially available from General Electric Company, Cincinnati, Ohio.

In operation, air flows through low pressure compressor 12 from an upstream side 28 of engine 10. Compressed air is supplied from low pressure compressor 12 to high pressure compressor 14. Highly compressed air is then delivered to combustor assembly 16 where it is mixed with fuel and ignited. Combustion gases are channeled from combustor 16 to drive turbines 18 and 20. The combustor assembly 16 includes an annular ring in which are mounted a plurality of combustor cups, typically between 18 and 30.

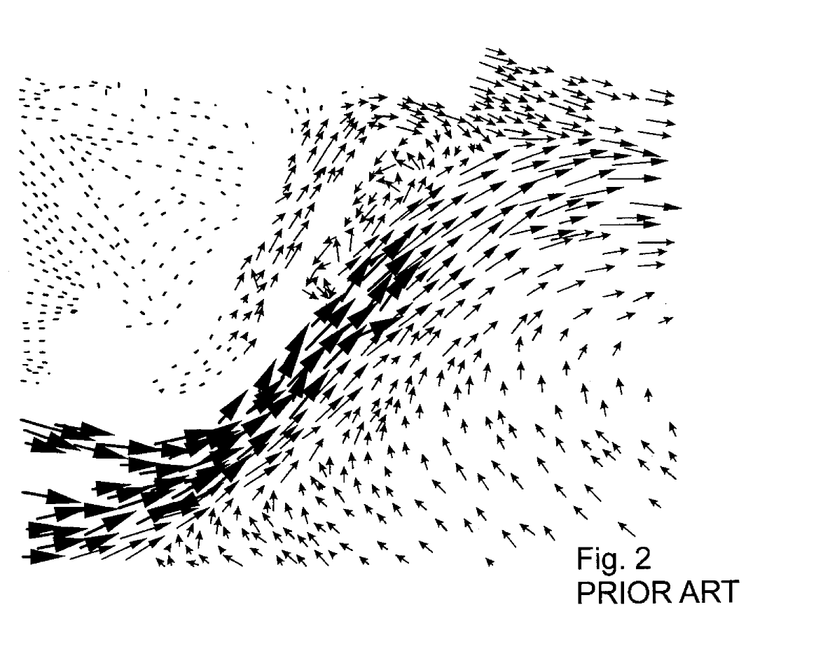

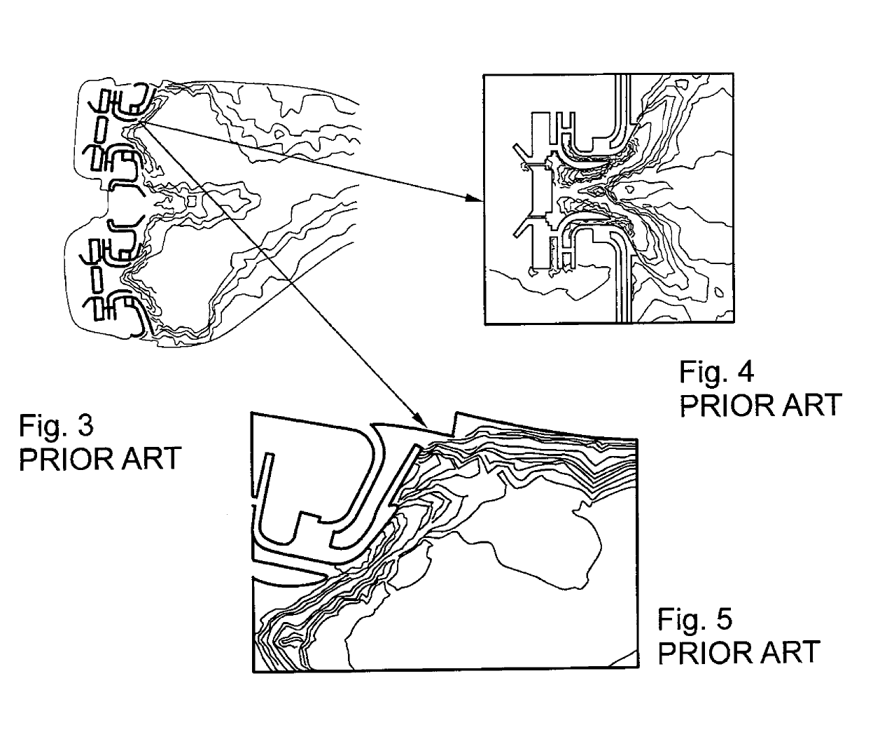

Referring now to FIG. 2, at each combustor cup, as the combustor air exits the swirlers, it expands and swirls with a significant tangential velocity. The velocity profile of the expanding air thus has a natural axi-symmetric conical shape. Current dome and deflector designs do not follow this natural conical axi-symmetric shape, causing the air to expand unevenly in the radial and tangential directions. This generates extremely high temperature gas recirculation zones. These zones trap hot gases and bring them to the close proximity of the deflector hence causing damage to the metal of the combustor, as shown in FIG. 3. This contact between the hot, recirculating gases and the combustor is shown in enlarged detail in the horizontal cross-section, FIG. 4, and in the vertical cross-section, FIG. 5.

In accordance with the invention, computational fluid dynamics techniques and analysis are carried out, and the deflector/flare surfaces are then contoured to match the streamlines from CFD analyses results. Contouring the deflector/flare surfaces in this manner eliminates or substantially reduces the existence of re-circulation zones and the resulting eddies that trap hot gases and cause engine damage.

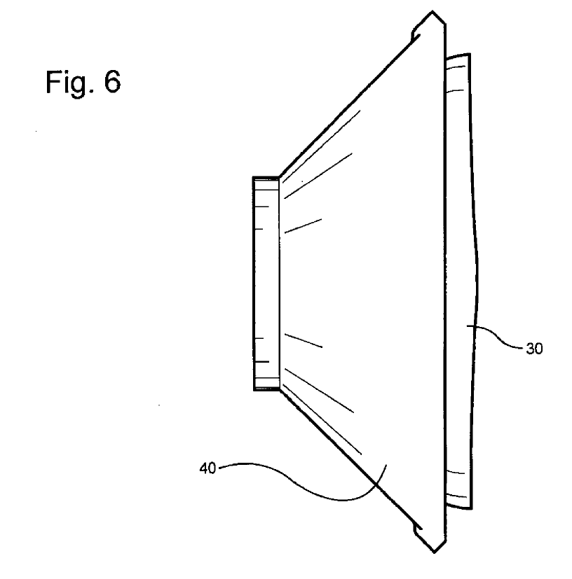

Referring to FIG. 6, the deflector 30 and dome 40 are integrated to form a conical shape for each combustor cup individually. As noted above, this eliminates the recirculation zones and swirling. Furthermore, air flow is contoured to expand as it moves downstream, providing cooling on the hot metal surfaces. The radiation heat load on the conical dome 40 is cooled by impinging on the back side of the deflector 30. To make the deflector cooling impingement effective, the dome is fabricated to follow the conical shape for each combustor cup. The gap between the conical deflector 30 and conical dome 40 is selected to satisfy a z/d ratio of 1-5, where “z” is normal to the impingement surface.

The deflector 30 and dome 40 are preferably stamped out of sheet metal with a constant wall thickness.

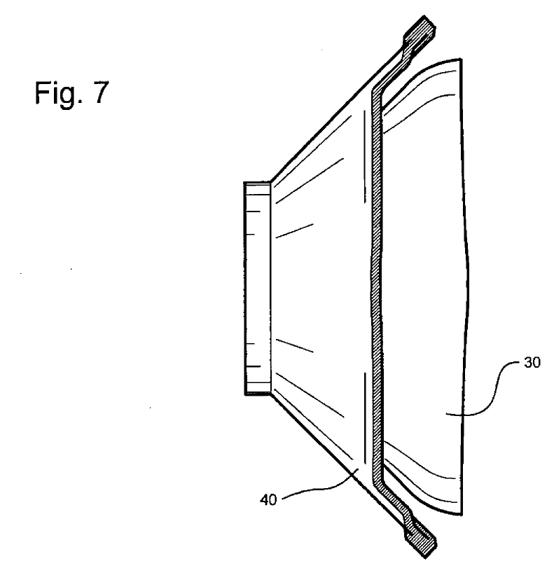

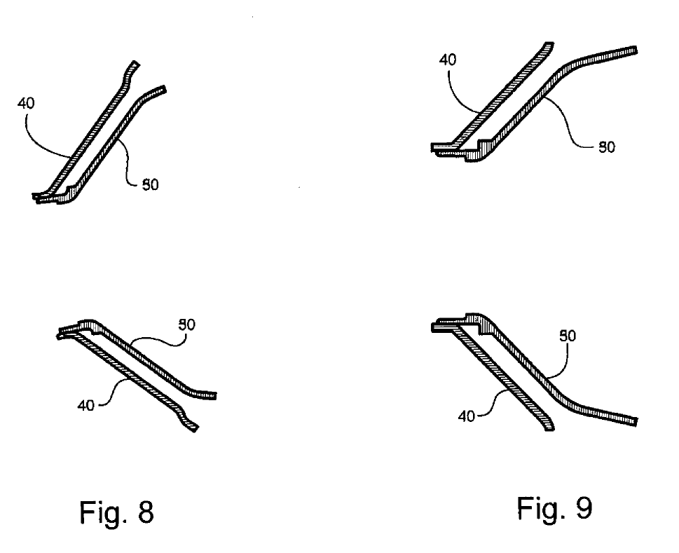

Referring to FIG. 7, part of the dome 40 has been cut away to indicate the inner edge surface profile of the dome 40 and upstream portions of the outer edge surface profile of the deflector 30. More specifically, in FIG. 8 the vertical cross-section of the outer edge surface profile of the dome and upstream portions of the outer edge surface profile of the deflector 30 are shown. By vertical is meant, aft looking forward, i.e., upstream into the gas flow, the 12 o'clock and 6 o'clock positions. FIG. 9 shows in horizontal cross-section the outer edge portions of the deflector 30 and dome 40. By horizontal is meant, aft looking forward, i.e., upstream into the gas flow, the 9 o'clock and 3 o'clock positions.

As is apparent, the integrated conical deflector 30 and dome 40 are not symmetrical, but are shaped to correspond to flow patterns indicated by CFD analysis as optimum for a given combustor.

Exemplary embodiments of combustor dome and deflector are described above in detail. The assemblies are not limited to the specific embodiments described herein, but rather, components of each assembly may be utilized independently and separately from other components described herein. Each dome assembly component can also be used in combination with other dome assembly components.

With the new conical dome and conical deflector design, the gas flow is attached and no re-circulation zones are present. Hot gases are not brought into contact with the surface of the deflector 30, hence resulting in a more durable part. The impingement cooling on the back side of the deflector 30 also removes heat loading due to radiation.

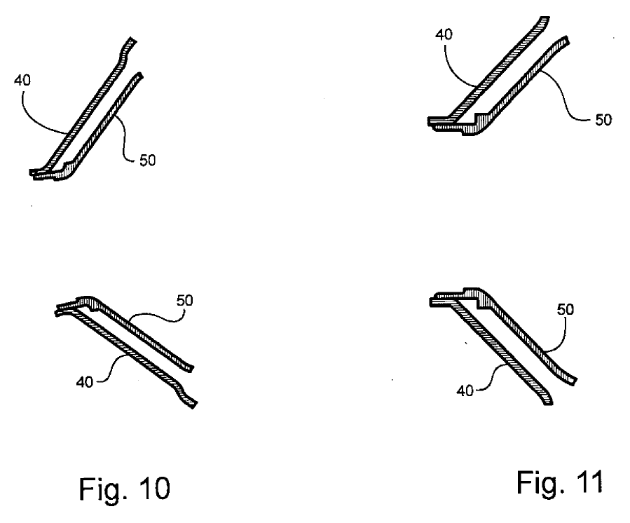

As a design option, the deflector edges, as shown on the deflector 50 in FIGS. 10 and 11, can be cut back, while maintaining the optimized shaping based on CFD analysis. FIG. 10 shows in vertical cross-section the outer edge portions of the deflector 50 and dome 40. FIG. 11 shows in horizontal cross-section the outer edge portions of the deflector 50 and dome 40.

While the invention has been described in terms of various specific embodiments, those skilled in the art will recognize that the invention can be practiced with modification within the spirit and scope of the claims.

We claim:

1. A combustor for a gas turbine engine, and including an integrated dome and deflector having a conical shape optimized for each individual combustor cup in an array of combustor cups, as determined by CFD analysis for eliminating combustor air recirculation zones and swirling.

2. A combustor for a gas turbine engine according to claim 1, wherein the gap between adjacent dome and deflector surfaces is contoured to permit combustor air to expand as it moves downstream for providing air cooling on metal dome and deflector surfaces.

3. A combustor for a gas turbine engine according to claim 1, wherein the integrated dome and deflector form a gap therebetween having a first shape defined by a vertical cross-section of the edge portions of the dome and deflector and a second shape defined by a horizontal cross-section of the edge portions of the dome and deflector.

4. An integrated dome and deflector of a gas turbine engine combustor, the integrated dome and deflector each having a conical shape optimized for each individual combustor cup in an array of combustor cups, as determined by CFD analysis for eliminating combustor air recirculation zones and swirling.

5. An integrated dome and deflector for a gas turbine engine according to claim 4, wherein the gap between adjacent dome and deflector surfaces is contoured to permit combustor air to expand as it moves downstream for providing air cooling on metal dome and deflector surfaces.

6. An integrated dome and deflector for a gas turbine engine according to claim 4, wherein the integrated dome and deflector form a gap therebetween having a first shape defined by a vertical cross-section of the edge portions of the dome and deflector and a second shape defined by a horizontal cross-section of the edge portions of the dome and deflector.

7. A method of optimizing combustor air flow through a deflector and dome of a gas turbine engine combustor, comprising the steps of forming an integrated dome and deflector having a conical shape optimized for each individual combustor cup in an array of combustor cups, as determined by CFD analysis for eliminating combustor air recirculation zones and swirling.

8. A method according to claim 7, and including the step of forming a gap between adjacent dome and deflector surfaces that is contoured to permit combustor air to expand as it moves downstream for providing air cooling on metal dome and deflector surfaces.

9. A method according to claim 7, and including the step of forming a gap between adjacent dome and deflector surfaces having a first shape defined by a vertical cross-section of the edge portions of the dome and deflector and a second shape defined by a horizontal cross-section of the edge portions of the dome and deflector.

10. A method of optimizing combustor air flow through a deflector and dome of a gas turbine engine combustor, comprising the steps of performing computational fluid dynamics analysis on combustor cups of the combustor; optimizing the shape of both the deflector and dome through a vertical cross-section; optimizing the shape of both the deflector through a horizontal cross-section; defining a gap between the deflector and dome based on the optimized shapes of the deflector and dome through the vertical and horizontal cross-sections; and forming an integrated deflector and dome having respective shapes and defining a gap between the deflector and dome optimized for gas flow without combustion air recirculation zones and swirling.
